(19) United States
(12) Patent Application Publication
(10) Pub. No.: US 2008/0098997 A1
(43) Pub. Date: May 1, 2008

(54) SUPERCHARGED TUBE OF A VEHICLE AIR INTAKE STRUCTURE

(76) Inventor: Shu-Kuo Chen, Tainan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/554,841

(22) Filed: Oct. 31, 2006

(51) Int. Cl. F02M 27/00; F02M 35/02; F02B 33/00

(52) U.S. Cl. 123/539; 123/198 E; 123/559.1

(57) ABSTRACT

A supercharged tube of a vehicle air intake structure comprises a cover, a main body and a base. The cover having a reverse U-shaped cross section and an opening facing downward, a hollow portion of the cover for containing an air filter, and a top portion of the cover is defined with plural air inlet holes. The main body is disposed at a lower portion of the cover and is mounted with an air passage for receiving a reverse-stopping element that is formed with an air containing room for insertion of a radiator. Both sides of the main body are disposed with a sleeve communicating with the air containing room. The base is disposed at the lower portion of the main body and is contacted with the radiator, such that the high temperature of the radiator can be discharged from the main body and the base to the outside.

### BACKGROUND OF THE INVENTION

1. Field of the Invention

The present invention relates to a supercharged tube of a vehicle air intake structure, and more particularly to a supercharged tube of a vehicle air intake structure which has the function of radiation.

2. Description of the Prior Art

Nowadays, the crisis of power sources shortage is existed worldwide, and the problem of air pollution is becoming more and more serious, as a result, the automobile industry mainly depended on gasoline has faced with unprecedented predicaments, and all the automobile manufacturers are trying their best to research the vehicles that can save gasoline and of low pollution. The problems of fuel consuming and air pollution of the ordinary vehicles mainly because of the incomplete combustion of the gasoline, which are caused by the problem of “insufficiency of air intake”, thereby, in view of the problem of “insufficiency of air intake”, manufacturers have developed a product for facilitating the air intake of a vehicle engine, such as an air intake structure of vehicles disclosed in Taiwan Pat. No. 553313 (a conventional product described as follows). The conventional product is characterized in that: between a brake auxiliary device and an air collecting box is disposed a supercharged tube includes a housing, a lower seat and an air intake adjusting structure. One end of the housing is connected to a net filter layer, the lower seat is defined with a through hole for mounting the air intake adjusting structure, and the air intake adjusting structure includes an adjusting bolt, an air stone, an air intake pipe and a jointing sleeve. By such arrangements, a cross jointing pipe can be mounted between the air collecting box and the brake auxiliary device for connecting to the supercharged tube, such that when driving, the conventional product has the effects of improving power, facilitating brake, combusting completely and saving gasoline. Furthermore, in addition that the conventional product can be assembled between the brake auxiliary device and the air collecting box, the conventional product also can be assembled to an abandoned recycling pipe between the air collecting box and the brake auxiliary device. When the engine body combusts, the discharged waste gas will be collected in the air collecting box, at the same time, the supercharged tube will absorb the air by the pressure produced by the engine body, so that the air in the air collecting box will be enough to supply to the engine body.

However, when using the conventional product, since the housing and the lower seat are made of plastic, when assembling the conventional product to the abandoned recycling pipe between the air collecting box and the brake auxiliary device, plus the temperature of the waste gas discharged from the engine body is still high, the waste gas of high temperature via the air intake structure cannot be radiated appropriately. Thereby, the housing and the lower seat will be influenced by the high temperature continuously, and after a long period of using, the housing and the lower seat will be deformed and cannot be combined closely, as a result, the housing and the lower seat will be burst, so the conventional product is insecure.

The present invention has arisen to mitigate and/or obviate the afore-described disadvantages.

### SUMMARY OF THE INVENTION

The primary objective of the present invention is to provide a supercharged tube of a vehicle air intake structure, which can lower the high temperature of the waste gas recycled by an engine by the disposition of a radiator and the good conductivity of the supercharged tube.

The supercharged tube of a vehicle air intake structure comprises a cover, a main body and a base. The cover having a reverse U-shaped cross section, an opening of the cover is faced downward, a hollow portion of an inner part of the cover is provided for containing an air filter, and a top portion of the cover is defined with a plurality of air inlet holes. The main body is a good conductor and is disposed at a lower portion of the cover, and the main body is mounted with an air passage that is located at the power portion of the air filter and is provided for stuffing a reverse-stopping element. The lower portion of the reverse-stopping element is formed with an air containing room that is communicated with the air passage, and the lower portion of the air containing room is open for insertion of a radiator from the bottom of the main body. Both sides of the main body are disposed with a sleeve that is communicated with the air containing room, one of the sleeves is connected to an engine intake manifold, and the other sleeve is connected to a brake auxiliary device. The base is a good conductor and is disposed at the lower portion of the main body, and the base is contacted with the radiator, such that the high temperature of the radiator can be discharged from the main body and the base to the outside. By such arrangements, the waste gas of high temperature absorbed by the air inlet holes of the cover fills the space of the inner part of the cover, so that some dust is brought to the cover, and then the waste gas enters the air containing room of the main body via the reverse-stopping element after being filtered by the filtration of the air filter. At that time, the high temperature air in the air containing room will disperse its heat to the outside from the main body and the base via the radiator. And the characteristics of good conductivity of the main body and the base enable the heat to be discharged quickly, thus prolonging the life of the parts, recycling the waste gas in the engine effectively and reducing air pollution.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a supercharged tube of a vehicle air intake structure in accordance with a first embodiment of the present invention;

FIG. 2 is an assembly cross sectional view of the supercharged tube of a vehicle air intake structure in accordance with the first embodiment of the present invention; and

FIG. 3 is another assembly cross sectional view of a supercharged tube of a vehicle air intake structure in accordance with a second embodiment of the present invention.

### DETAILED DESCRIPTION OF THE PREFERRED EMBODIMENTS

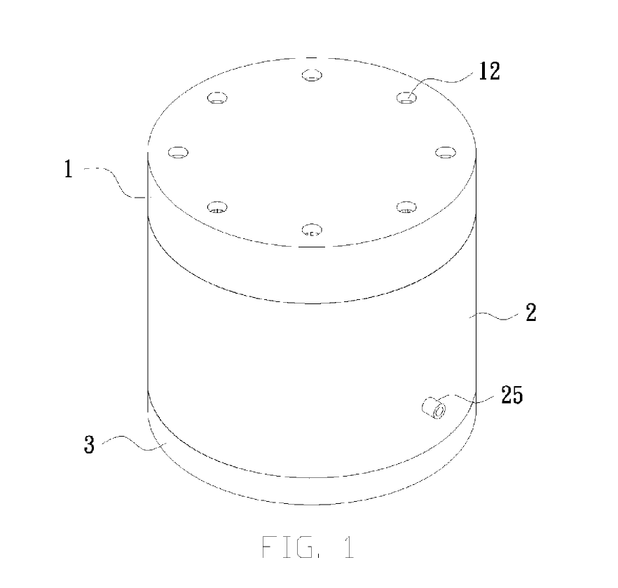

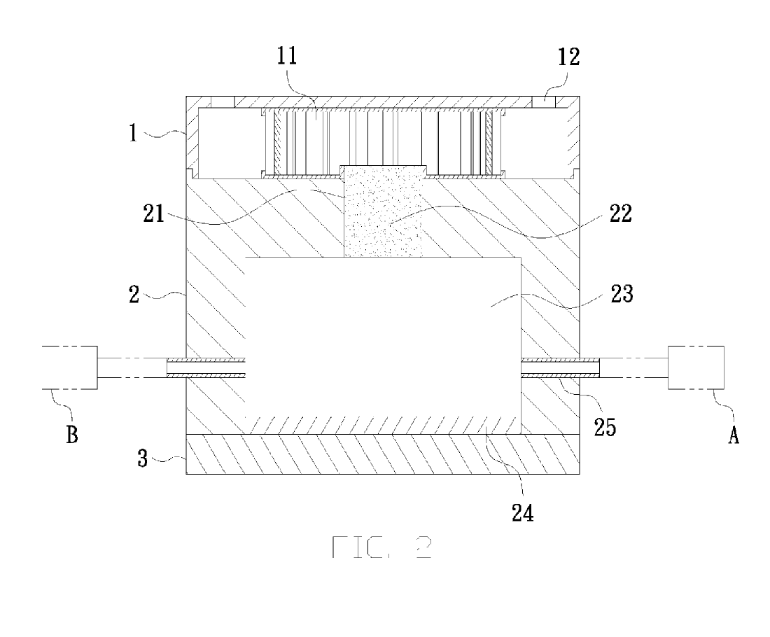

Referring to FIGS. 1 and 2, a supercharged tube of a vehicle air intake structure in accordance with a first embodiment of the present invention comprises a cover 1, a main body 2 and a base 3.

The cover 1, an opening of the cover 1 is faced downward, a hollow portion of an inner part of the cover 1 is provided for containing an air filter 11, and the top portion of the cover 1 is defined with a plurality of air inlet holes 12 that are arranged in an annular fashion.

The main body 2 is a good conductor made of aluminum alloy and is disposed at a lower portion of the cover 1, and the main body 2 is mounted with an air passage 21 that is located at the power portion of the air filter 11 and is provided for receiving a reverse-stopping element 22. The reverse-stopping element 22 is an air stone formed with plural air holes by sintering copper, and the reverse-stopping element 22 tapers from one end to the other end. The lower portion of the reverse-stopping element 22 is formed with an air containing room 23 that is communicated with the air passage 21, and the lower portion of the air containing room 23 is open for insertion of a radiator 24 from the bottom of the main body. Both sides of the main body 2 are disposed with a sleeve 25 that is communicated with the air containing room 23, one of the sleeves 25 is connected to an engine intake manifold A, and the other sleeve 25 is connected to a brake auxiliary device B.

The base 3 is a good conductor made of aluminum alloy and is disposed at the lower portion of the main body 2, and the base 3 is contacted with the radiator 24, such that the high temperature of the radiator 24 can be discharged from the main body 2 and the base 3 to the outside.

When operating, the waste gas of high temperature absorbed by the air inlet holes 1 2 of the cover 1 fills the space of the inner part of the cover 1, so that some dust is brought to the cover 1, and then the waste gas enters the air containing room 23 of the main body 2 via the reverse-stopping element 22 after being filtered by the filtration of the air filter 11. Since the reverse-stopping element 22 tapers from one end to the other end, the air can only be allowed to flow in one direction. Thereby, the air only can flow to the air containing room 23 from the direction of the cover 1, and cannot flow back to the cover 1 from the air containing room 23. At that time, the high temperature air in the air containing room 23 will disperse its heat to the outside from the main body 2 and the base 3 via the radiator 24. And the characteristics of good conductivity of the main body 2 and the base 3 enable the heat to be discharged quickly, thus prolonging the life of the parts, recycling the waste gas in the engine effectively and reducing air pollution.

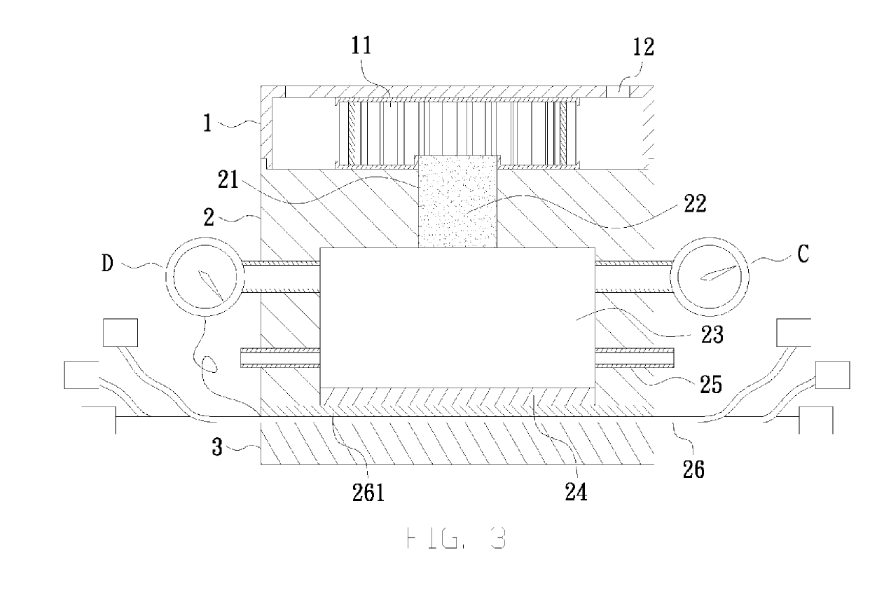

With reference to FIG. 3, a supercharged tube of a vehicle air intake structure in accordance with a second embodiment of the present invention is shown, wherein both sides of the main body 2 are disposed with a variometer C and a voltmeter D. The intermediate portion of the radiator 24 and the base 3 is provided for passing through a guiding wire 26 that has the high temperature resisting property, and between the guiding wire 26 and the radiator 24 is formed a radiating layer 261 for the radiation of the guiding wire 26. The guiding wire 26 is connected to the voltmeter D, and both ends of the guiding wire 26 are diverged to form three sections, one end of the guiding wire 26 is connected to a main wire of a generator, a ground wire of the generator and the engine body, and the other end of the guiding wire 26 is connected to the positive and negative electrodes of a storage battery and the ground wire of the vehicle. Therefore, the leak electricity produced by the rotation of the engine can be effectively guided to the ground, thus solving the problems of burning the vehicle and getting an electric shock. Furthermore, the remaining electricity can be recycled and returned to the storage battery and the generator to stable the working of the computer and reduce the damage of the sensor.

To summarize, the present invention has the following advantages:

Firstly, compared with the conventional inventions, the supercharged tube of a vehicle air intake structure of the present invention is new.

Secondly, when the waste gas of high temperature absorbed by the air inlet holes of the cover fills the space of the inner part of the cover, some dust is brought to the cover, the user only needed to clean the cover, thus the life of the air filter is prolonged, so the present invention is practical.

Thirdly, the radiator can disperse the heat of the high temperature air in the air containing room effectively to prevent the parts from being deformed, so the present invention is safe.

Fourthly, the waste gas can be recycled, so the present invention can reduce air pollution, save gas, and is very practical.

Fifthly, the present invention is not only can disperse the heat of the high temperature air, but also can disperse the heat produced by the guiding wire via the radiating layer.

While we have shown and described various embodiments in accordance with the present invention, it should be clear to those skilled in the art that further embodiments may be made without departing from the scope of the present invention.

What is claimed is:

1. A supercharged tube of a vehicle air intake structure, comprising a cover, a main body and a base;
the cover with an opening of the cover facing downward, a hollow portion formed in the cover and provided for containing an air filter, and a top portion of the cover being defined with a plurality of air inlet holes;
the main body, being a good conductor and disposed at a lower portion of the cover, the main body being mounted with an air passage located at the power portion of the air filter for receiving a reverse-stopping element, the lower portion of the reverse-stopping element being formed with an air containing room communicated with the air passage, the lower portion of the air containing room being open for insertion of a radiator from the bottom of the main body, both sides of the main body being disposed with a sleeve communicated with the air containing room, one of the sleeves being connected to an air collecting box, and the other sleeve being connected to a brake auxiliary device;
the base, being a good conductor and disposed at the lower portion of the main body, and the base being contacted with the radiator, such that the high temperature of the radiator being discharged from the main body and the base to the outside.

2. The supercharged tube of a vehicle air intake structure as claimed in claim 1, wherein the air inlet holes of the cover are arranged in an annular fashion.

3. The supercharged tube of a vehicle air intake structure as claimed in claim 1, wherein the main body and the base are good conductors made of aluminum alloy.

4. The supercharged tube of a vehicle air intake structure as claimed in claim 1, wherein the reverse-stopping element is an air stone formed with plural air holes by sintering copper, and the reverse-stopping element tapers from one end to the other end, thereby, the air only allowed to flow to the air containing room from the direction of the cover, and disallowed to flow back to the cover from the air containing room.

5. The supercharged tube of a vehicle air intake structure as claimed in claim 1, wherein a variometer and a voltmeter are disposed on both sides of the main body, an intermediate portion of the radiator and the base is provided for passing through a guiding wire, between the guiding wire and the radiator is formed a radiating layer for the radiation of the guiding wire, and the guiding wire is connected to the voltmeter.

6. The supercharged tube of a vehicle air intake structure as claimed in claim 5, wherein the guiding wire has the high temperature resisting property, both ends of the guiding wire are diverged to form three sections, one end of the guiding wire is connected to a main wire of a generator, a ground wire of the generator and the engine body, and the other end of the guiding wire is connected to positive and negative electrodes of a storage battery and the ground wire of the vehicle.
